(19) United States
(12) Patent Application Publication
(10) Pub. No.: US 2009/0077553 A1
(43) Pub. Date: Mar. 19, 2009

(54) PARALLEL PROCESSING OF PLATFORM LEVEL CHANGES DURING SYSTEM QUIESCE

(76) Inventors: Jian Tang, Shanghai (CN); Yufu Li, Shanghai (CN)

Correspondence Address: SCHWEGMAN, LUNDBERG & WOESSNER, P.A., P.O. BOX 2938, MINNEAPOLIS, MN, 55402, US

(21) Appl. No.: 11/854,953

(22) Filed: Sep. 13, 2007

(51) Int. Cl. G06F 9/46

(52) U.S. Cl. 718/100

(57) ABSTRACT

Various embodiments described herein provide one or more of systems, methods, and software/firmware that provide increased efficiency in implementing configuration changes during system quiesce time. Some embodiments may separate a quiesce data buffer into small slices wherein each slice includes configuration change data or instructions. These slices may be individually distributed by a system bootstrap processor, or other processor, to other processors or logical processors of a multi-core processor in the system. In some such embodiments, the system bootstrap processor and application processors may change system configuration in parallel while a system is in a quiesce state so as to minimize time spent in the quiesce state. Furthermore, typical system configuration change become local operations, such as local hardware register modifications, which suffer much less transaction delay than remote hardware register accesses as has been previously performed. These embodiments, and others, are described in greater detail herein.

### BACKGROUND INFORMATION

Server computer systems demand high levels of reliability, availability and serviceability (“RAS”). Reliability, availability, and serviceability are enhanced in some servers through RAS features. Some RAS features a allow, a system configuration changes, such as changes necessary for link, memory, and processor maintenance and swapping, may be made in an Operating System (“OS”) transparent manner. Some system architectures utilizes System Management Interrupts (“SMI”) to implement RAS features, but to meet real-time demands in such systems, SMI latency limits are in the order of microseconds. In link-based systems, to change system configuration requires the system to enter a quiesce state to pause OS execution, such as for several milliseconds. Current operating systems are not tolerant of long time tick losses while the underlying system is in a quiesce state. Some previous efforts have utilized a quiesce data buffer to separate data calculations from the data commitment, or configuration change implementation. Such efforts have been successful in reducing quiesce time, but as systems continue to increase in the number of included resources, such as an increased number of processors, these efforts have limitations. Further, these efforts utilize only a single processors designated as a System Bootstrap Processor (“SBSP”) to implement configuration changes while in a quiesce state. All Application Processors (“AP”) are placed in an idle loop during system quiesce and do not participate in the implementation of the configuration changes.

### BRIEF DESCRIPTION OF THE DRAWINGS

FIG. 1 is a logical block diagram of a system according to an example embodiment.

FIG. 2 is a block flow diagram of a method according to an example embodiment.

FIG. 3 is a block flow diagram of a method according to an example embodiment.

### DETAILED DESCRIPTION

Various embodiments described herein provide one or more of systems, methods, and software/firmware that provide increased efficiency in implementing configuration changes during system quiesce time. Some embodiments may separate a quiesce data buffer into small slices wherein each slice includes configuration change data or instructions. These slices may be individually distributed by a system bootstrap processor, or other processor, to other processors or logical processors of a multi-core processor in the system. In some such embodiments, the system bootstrap processor and application processors may change system configuration in parallel while a system is in a quiesce state so as to minimize time spent in the quiesce state. Furthermore, typical system configuration change become local operations, such as local hardware register modifications, which suffer much less transaction delay than remote hardware register accesses as has been previously performed. These embodiments, and others, are described in greater detail herein.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

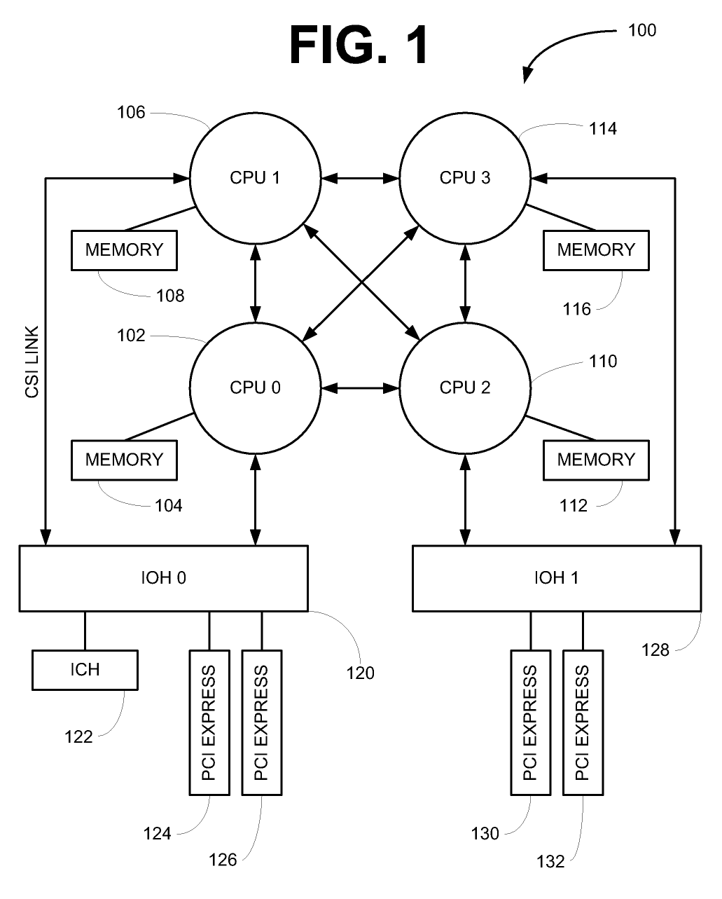

FIG. 1 is a logical block diagram of a system 100 according to an example embodiment. The system 100 includes four central processing units CPU 0 102, CPU 1 106, CPU 2 110, and CPU 3 114. The central processors 102, 106, 110, 114 each include a local memory subsystem 104, 108, 112, and 116, respectively. The system 100 also includes two input/output hubs IOH 0 120 and IOH 1 128. Although the system 100 includes four processors 102, 106, 110, 114 and two IOHs 120, 128, other embodiments may include as few as two processors and one IOH to virtually any number of processors and IOHs. The input/output hubs 120, 128 provide connectivity to input/output devices, such as input/output controller hub 122 and PCI Express 124, 126, 130, 132. Processor to processor and processor to input/output hub 120, 128 communication may be performed using Common System Interface (“CSI”) packets. Each CSI component contains a Routing Table Array (“RTA”) and a SAD. The RTA provides the CSI packet routing information to other sockets. The SAD provides mechanisms to represent routing of the resources such as memory, input/output, and the like. Each CPU 102, 106, 110, 114 also contains a Target Address Decoder (“TAD”). The TAD provides mechanisms to map system addresses to processor 102, 106, 110, 114 memory 104, 108, 112, 116 addresses.

In system 100 as an example embodiment, one of the processors 102, 106, 110, 114 is designated as a system bootstrap processor (“SBSP”). The non-SBSP processors are then designated as application processors (“AP”).

In a common scenario, assume the CPU3 114 needs to be removed from service along with its local memory 116 while an operating system is running on the system 100. Removal of CPU 3 114 requires RTA and SAD reconfigurations such that the related entries are removed on all the other CSI components, which may include CPU 0 102, CPU 1 106, CPU 2 110, IOH 0 120, and IOH 1 128. CSI components, in some links based embodiments, support a quiesce mode by which normal traffic may be paused to perform the RTA/SAD change operations.

When the processor 114 and memory 116 are ready to be removed, a system management interrupt (“SMI”) may be generated to begin the remove operation. However, prior to placing the system in a quiesce state, the SBSP calculates configuration data changes and may register the configuration data to a quiesce data buffer.

The SBSP then organizes the data in the quiesce data buffer, or other location into slices. Each slice may correspond to one processor socket or logical processor in the system and only contains Quiesce data which belongs to that socket, processor, or its neighbor IOH. For example, a slice for processor socket 0 102 may contains all RTA/SAD entries needed to be updated in processor socket 0 102 and IOH socket 0 120.

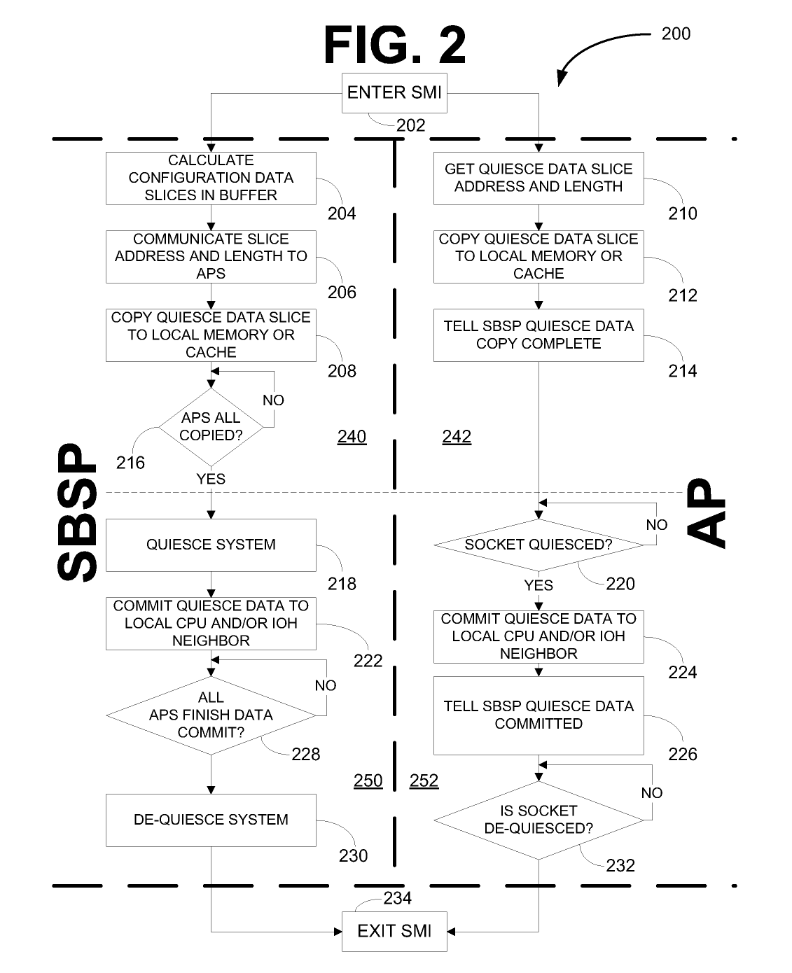

FIG. 2 is a block flow diagram of a method 200 according to an example embodiment. The example method 200 is a method of applying system configuration changes during runtime of a multi-processor system utilizing multiple processors in parallel. The example method 200 includes entering a SMI 202. Upon entering the SMI 202, the method 200 branches into two portions. These portions include a SBSP portion and an AP portion that may be performed by one or more APs, depending on the number of processors, logical or physical, in a particular embodiment. Each of the SBSP and AP portions are broken into two sub-portions. These sub-portions include pre-quiesce sub-portions 240 and 242 and quiesce sub-portions 250 and 252.

The pre-quiesce sub-portion 240 of the SBSP portion may include calculating configuration data slices in a buffer 204. Such calculations may include determining what and where configuration changes need to be made as a function of the SMI. The calculation of configuration data slices in the buffer 204 may also include slicing the data as a function of processors and there location in reference to other system components such as IOHs and slices of configuration changes assigned to other APs. For example, if two processors are neighbors of an IOH and only one processor has local configuration changes, configuration changes may be placed in a slice of the other processor that are to be implemented within the IOH.

After the slices are calculated 204, the method 200 further includes communicating the slices to the APs 206. The slices may be communicated 206 in any number of ways. One way may include utilization of a globally accessible register or memory location to place the slices in for pickup by the APs. Another way to communicate the slices may include packetized CSI messages or messages sent via another suitable technology. The slices are typically communicated as a starting address and bit or byte length of the slice in a shared memory. However, other embodiments may include communicating the actual data of the slice which may eliminate some memory operations necessary for an AP to obtain a slice.

The method 200 continues with the SBSP copying a quiesce data slice allocated to the SBSP into local memory or cache 208. The pre-quiesce sub-portion 240 concludes by determining 216 if each AP has copied, or otherwise received, its respective slice.

Referring now to the AP pre-quiesce sub-portion 242, the method 200 includes the AP getting a quiesce data slice address and length 210 from the mailbox mechanism, via a message, or in another way depending on the particular embodiment. The AP may then copy the quiesce data slice to local memory or cache 212. However, as noted above, the getting of the quiesce data slice address and length 210 and copying of the quiesce data slice 212 may be a single operation. After the AP copies, or otherwise places, the data into local memory or cache 212, the AP tells the SBSP that the quiesce data copy is complete 214. Again, this messaging maybe made utilizing a mailbox mechanism or other messaging technology. Note that although only a single AP portion of the method 200 is illustrated, the same AP portion of the method may be performed in parallel by virtually any number of APs. Further, the AP portion of the method 200 may be performed in parallel with the SBSP portion of the method 200.

At this point, the method 200 is ready to enter the system into a quiesced state. Referring now to the quiesce sub-portion 250 of the SBSP portion, the method 200 includes quiescing the system 218. The SBSP then processes it quiesce data slice, if one is assigned, and commits the quiesce data to the local CPU and/or IOH neighbor 222. At this point, the SBSP determines when all of the APs have finished committing their respective data slices 228 and then de-quiesces the system 230.

At the same time as the quiesce sub-portion 250 of the SBSP portion of the method 200 is being processed, the quiesce sub-portion 252 of the AP portion is processed. This sub-portion 252 of the method 200 includes the AP determining if the socket of the AP is quiesced 220. Once quiesced, the AP processes it quiesce data slice, if one is assigned, and commits the quiesce data to the local CPU and/or IOH neighbor 224. After committing the quiesce data 224, the AP tells the SBSP the quiesced data has been committed 226 and the AP waits for its socket to be de-quiesced 232. Once all of the AP sockets have been de-quiesced 232 and the SBSP has de-quiesced the remainder of the system 230, both the AP and SBSP portions of the method exit the SMI state 234 and the method 200 is complete.

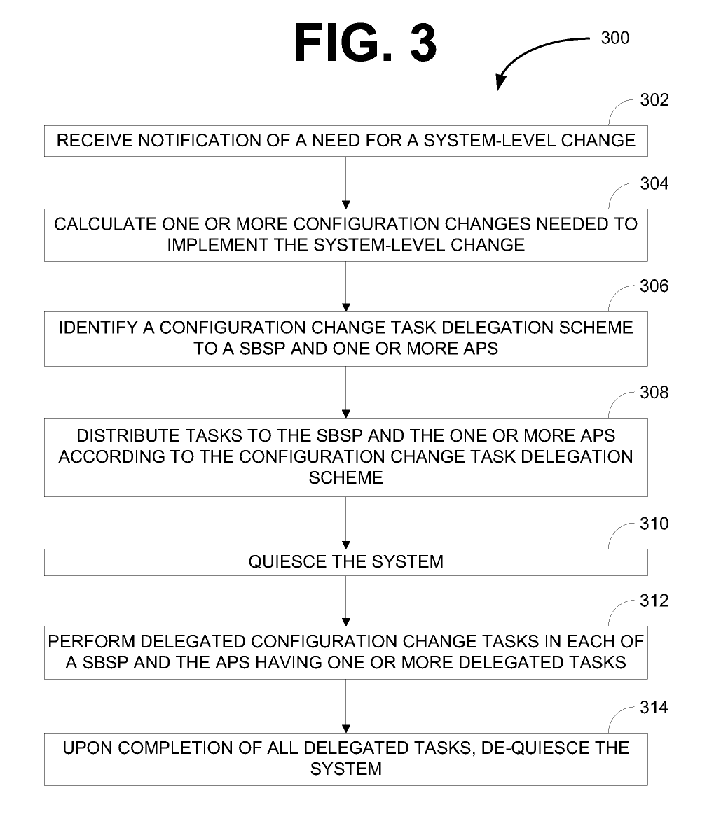

FIG. 3 is a block flow diagram of a method 300 according to an example embodiment. The example method 300 includes receiving notification of a need for a system-level change 302 and calculating one or more configuration changes needed to implement the system-level change 304. The method 300 then typically identifies a configuration change task delegation scheme to the SBSP and one or more APs 306 and distributes tasks to the SBSP and the one or more APs according to the configuration change task delegation scheme 308. The method 300 may then quiesce the system 310 and perform delegated configuration change tasks in SBSP and each of the APs having one or more delegated tasks 312 and upon completion of all delegated tasks, de-quiesce the system 314. In some embodiments of the method 300 the received notification of the need for a system-level change is a system management interrupt. Each AP, upon receipt of one or more delegated configuration change tasks, may copy the configuration change tasks to a memory local to the respective AP. A delegated configuration change task may include one or more configuration settings to commit to the system.

In various embodiments, needed configuration changes may include one or more of an update to a routing table array (“RTA”), a source address decoder, a target address decoder, or other configuration setting depending on the needed change and the particular system of the embodiment. Such changes may be needed due to addition or subtraction of an element from a computing environment of the system, detected errors within the system, or other events that may necessitate a system configuration change.

In some embodiments of the method 300, identifying the configuration change task delegation scheme 306 may include identifying one or more configuration settings in need of modification, identifying a location of where the one or more configuration settings are located and tasking processors with needed configuration changes with making their own configuration changes. Identifying the configuration change task delegation scheme 306 may also include identifying and tasking a processor not already tasked with a configuration change task in proximity to each device in need of a configuration change to make the needed device configuration changes.

In some embodiments, either of the methods 200, of FIG. 2, and 300, of FIG. 3, may be encoded as an instruction set on a computer readable medium, which when executed, will cause a system to implement one or both of the methods 200 or 300. The computer readable may be a tangible and/or physical computer readable medium. The computer readable medium may be a volatile or non-volatile memory within a computing device, a magnetic or optical removable disk, a hard disk, or other suitable local, remote, or removable data storage mechanism or device. Thus, the encoded instruction set may be thought of as either firmware or software. However, as used herein, the terms firmware and software are interchangeable and no difference is intended between use of the terms, unless explicitly stated otherwise.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving notification of a need for a system-level change;
calculating one or more configuration changes needed to implement the system-level change;
identifying a configuration change task delegation scheme to a system bootstrap processor (“SBSP”) and one or more application processors (“AP”);
distributing tasks to the SBSP and the one or more APs according to the configuration change task delegation scheme;
quiescing the system;
performing delegated configuration change tasks in SBSP and each of the APs having one or more delegated tasks; and
upon completion of all delegated tasks, de-quiescing the system.

2. The method of claim 1, wherein the received notification of the need for a system-level change is a system management interrupt.

3. The method of claim 1, wherein each AP, upon receipt of one or more delegated configuration change tasks, copies the configuration change tasks to a memory local to the respective AP.

4. The method of claim 3, wherein a delegated configuration change task includes one or more configuration settings to commit to the system.

5. The method of claim 1, wherein a needed configuration change includes an update to a routing table array.

6. The method of claim 1, wherein identifying the configuration change task delegation scheme includes:
identifying one or more configuration settings in need of modification;
identifying a location of where the one or more configuration settings are located;
tasking processors with needed configuration changes with making their own configuration changes; and
identifying and tasking a processor not already tasked with a configuration change task in proximity to each device in need of a configuration change to make the needed device configuration changes.

7. A computer readable medium, with instructions thereon, which when executed, cause a system to implement the method of claim 1.

8. A system comprising:
two or more processing units, each processing unit including a local memory, one processor of which is designated a system bootstrap processor (“SBSP”) and the others designated as application processors (“AP”);
one or more input/output hubs each coupled to at least one processor;
a system management interrupt handling module operable on the system to process a system management interrupt (“SMI”) by:
calculating one or more configuration changes needed to implement a needed system-level change identified as a function of the SMI;
identifying a configuration change task delegation scheme and distributing tasks to the SBSP and one or more APs; and
quiescing the system and performing delegated configuration change tasks in each of a SBSP and APs having one or more delegated tasks;
upon completion of all delegated tasks, de-quiescing the system.

9. The system of claim 8, wherein each AP, upon receipt of one or more delegated configuration change tasks, copies the configuration change tasks to it local memory.

10. The system of claim 9, wherein a delegated configuration change task includes one or more configuration settings to commit to the system.

11. The system of claim 8, wherein a needed configuration change includes an update to a routing table array.

12. The system of claim 8, wherein the system management interrupt handling module, when identifying the configuration change task delegation scheme, is operable to:
identify one or more configuration settings in need of modification;
identify a location of where the one or more configuration settings are located;
task processors with needed configuration changes with making their own configuration changes; and
identify and tasking a processor not already tasked with a configuration change task in proximity to each device in need of a configuration change to make the needed device configuration changes.
